(19) United States
(12) Patent Application Publication
(10) Pub. No.: US 2005/0162021 A1
(43) Pub. Date: Jul. 28, 2005

(54) Information handling system including zero voltage switching power supply

(75) Inventor: Daniel E. Jenkins, Bastrop, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/764,627

(22) Filed: Jan. 26, 2004

(51) Int. Cl. H01H 1/00

(52) U.S. Cl. 307/134

(57) ABSTRACT

An information handling system (IHS) is provided which is powered by a zero voltage switching power supply. The power supply is capable of maintaining regulation even under very light loads. The supply includes first and second switches arranged in complementary configuration to deliver current to a load dependent inductor. This load dependent inductor acts as an energy source which supplies energy to parasitic elements in the first and second switches to aid in switching of the first and second switches during power supply operation.

### BACKGROUND

The disclosures herein relate generally to information handling systems (IHS's) and more particularly to switching power supplies for IHS's.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

IHS's often employ switching power supplies to provide voltage and current to the various circuits within IHS's. One typical type of switching power supply includes a pair of switching transistors which are alternately switched on and off to provide energy to an inductor, capacitor and resistive load. Early switching power supplies employed driver circuitry to provide drive signals to turn the switching transistors on and off as needed. Unfortunately the drive signals required significant energy to perform the switching function and this contributed to relatively low operational efficiency of these supplies. Zero voltage switching power supplies were developed to minimize the voltage and energy needed to turn the switching transistors on and off. In this approach, the energy stored in the inductor is used to assist the switching of the switching transistors. One zero voltage switching power supply approach is described in the publication, Zero-Voltage Switching Quasi Square Wave Converters, by Igor Goryanskey, NIFKI, Moscow, Russia, the disclosure of which is incorporated herein by reference.

Unfortunately, while the zero voltage switching power supply approach increases overall efficiency, another problem is encountered when zero voltage switching is employed. Under very low loads, namely high impedance loads, the size of the inductor must be very large in order for zero voltage switching to occur. This is so because there must be sufficient current flowing in the inductor so that the inductor has enough energy to provide zero voltage switching. If the load is light, namely high impedance, the inductor current can be so small that the field around the inductor is insufficient to provide the energy needed for zero voltage switching.

What is needed is a way to achieve zero voltage switching in a switching power supply even under low load conditions.

### SUMMARY

Accordingly, in one embodiment, a method is disclosed for operating an information handling system (IHS) including a switching power supply. The method includes storing energy in a load dependent inductor exhibiting an inductance which increases as current through the inductor decreases. The method also includes supplying energy from the load dependent inductor to switches in the switching power supply to achieve zero voltage switching of the switches. The method further includes providing energy from the switching power supply to power the IHS.

In another embodiment, an information handling system (IHS) is disclosed which includes a processor and a memory coupled to the processor. The IHS also includes a power input coupled to the processor and the memory. The IHS further includes a switching power supply coupled to the power input. The switching power supply includes a load dependent inductor for storing energy, the load dependent inductor exhibiting an inductance which increases as current through the inductor decreases. The switching power supply also includes first and second switches arranged in complementary configuration, the load dependent inductor supplying energy to the first and second switches to achieve zero voltage switching of the first and second switches.

### BRIEF DESCRIPTION OF THE DRAWINGS

FIG. 1 is a block diagram of the disclosed information handling system (IHS).

FIG. 2 is a representation of the zero voltage switching power supply in the IHS of FIG. 1.

FIG. 3A is a representation of a conventional inductor with a core having a constant gap distance.

FIG. 3B-3D are representations of inductors with a cores having non-constant gap distances.

FIG. 4A is a representation of a conventional inductor with a core having a constant gap distance.

FIG. 4B-4G are representations of inductors with cores having non-constant gap distances.

FIG. 5A-5E are representations of inductors with cores having non-constant gap distances.

### DETAILED DESCRIPTION

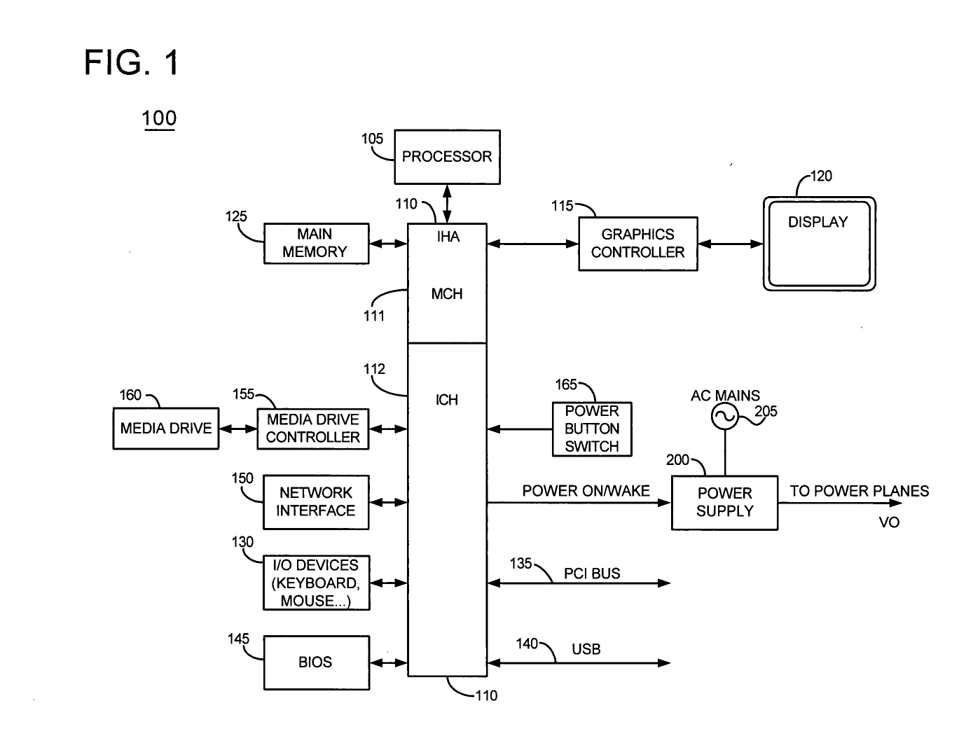

FIG. 1 is a block diagram of the disclosed information handling system (IHS) 100 employing a zero voltage switching power supply 200. For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In one embodiment, IHS 100 includes a processor 105 such as an Intel Pentium series processor or one of many other processors currently available. An Intel Hub Architecture (IHA) chipset 110 provides IHS 100 with glue-logic that connects processor 105 to other components of IHS 100. Chipset 110 carries out graphics/memory controller hub functions in its memory controller hub or MCH 111. Chipset 110 carries out I/O controller functions in its I/O controller hub or ICH 112. More specifically, the MCH 111 of chipset 110 acts as a host controller which communicates with a graphics controller 115 coupled thereto. Graphics controller 115 is coupled to a display 120. The MCH of chipset 110 also acts as a controller for main memory 125 which is coupled thereto.

Input devices 130 such as a mouse, keyboard, and tablet, are coupled to the ICH 112 of chipset 110. An expansion bus 135, such as a Peripheral Component Interconnect (PCI) bus, PCI Express bus, SATA bus or other bus is coupled to chipset 110 as shown to enable IHS 100 to be connected to other devices which provide IHS 100 with additional functionality. A peripheral device bus 140 such as a universal serial bus (USB) is coupled to the ICH of chipset 110 as shown. System basic input-output system (BIOS) 145 is coupled to chipset 110 as shown. A nonvolatile memory such as CMOS or FLASH memory is used to store BIOS software 145. A network interface controller (NIC) 150 is coupled to ICH of chipset 110 to facilitate connection of system 100 to other information handling systems. A media drive controller 155 is coupled to the ICH of chipset 110 so that devices such as media drive 160 can be connected to chipset 110 and processor 105. Devices that can be coupled to media drive controller 155 include CD-ROM drives, DVD drives, hard disk drives and other fixed or removable media drives. IHS 100 includes an operating system which is stored on media drive 160. Typical operating systems which can be stored on media drive 160 include Microsoft Windows XP, Microsoft Windows 2000 and the Linux operating systems. (Microsoft and Windows are trademarks of Microsoft Corporation.)

IHS 100 includes a main power button switch 165 coupled to chipset 110. When main power button switch 165 is pressed, chipset 110 generates a power on/wake signal which is supplied to a power supply 200 that is coupled to chipset 110. Power supply 200 includes an output VO which is coupled to one or more power planes in IHS 100. When power button 165 is pressed the power on/wake signal instructs power supply 200 to turn on and supply an output voltage, VO.

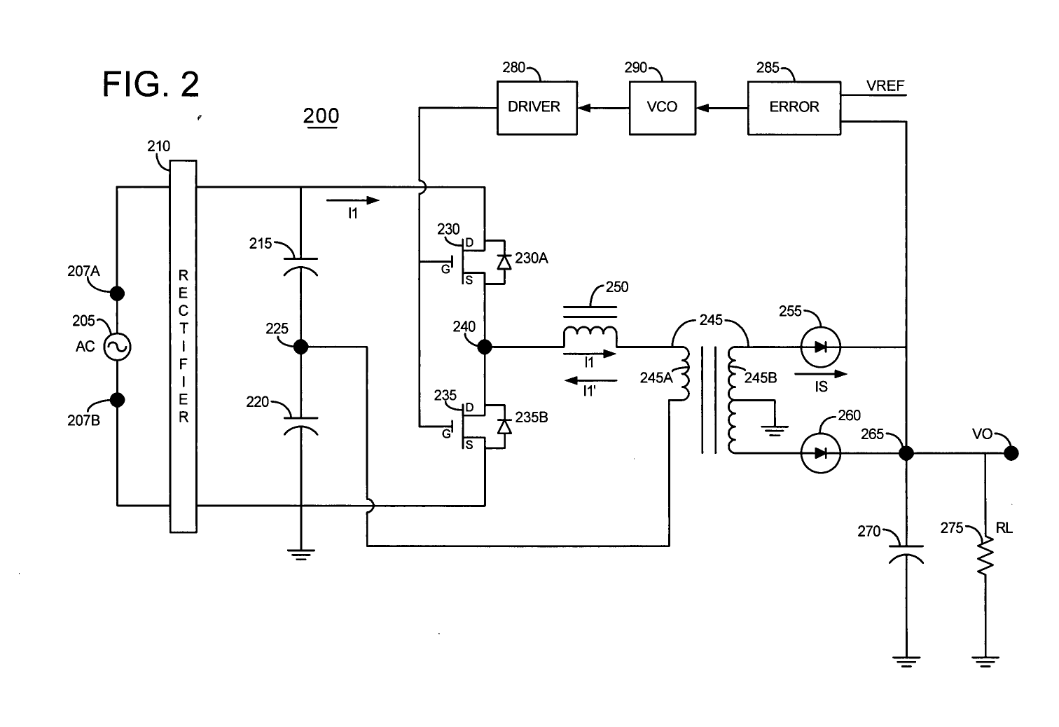

FIG. 2 is a schematic diagram of one embodiment of power supply 200. Power supply 200 includes an input 207A, 207B which is connected to AC mains 205. Power supply 200 includes a rectifier 210 which is coupled across input 207A, 207B to rectify AC mains power from AC to pulsating DC. Capacitors 215, 220 are coupled together at node 225. The split capacitor structure 215, 220 thus formed is coupled across rectifier 210 as shown. Switches 230, 235 are coupled to a common node 240 as shown. The switching circuit formed by switches 230, 235 is coupled in parallel with split capacitor 215, 220 and rectifier 210. Switches 230, 235 can be virtually any electronic switch, for example, FETs, bipolar transistors, SCRs, triacs and so forth.

Power supply 200 includes a transformer 245 having a primary winding 245A and a secondary winding 245B. An inductor 250 is coupled in series with primary winding 245A. The structure thus formed by inductor 250 and primary winding 245A is coupled across nodes 225 and 240 as shown. The ends of secondary winding 245B are coupled by respective diodes 255 and 260 to a node 265. An output capacitor 270 is coupled between node 265 and ground. A load 275, such as the power plane or planes of an IHS, is coupled between node 265 and ground.

Switches 230 and 235 are alternately opened and closed in complementary fashion while supply 200 operates. Switching signals from driver 280 are provided to switches 230 and 235 as part of the switching process. The output voltage VO is compared with a desired output reference voltage, VREF, by error comparator 285. An error signal is generated at the output of error comparator 285 which is coupled to a voltage controlled oscillator (VCO) 290. The error signal is an indication of how far off the actual output voltage, VO, is from the desired output voltage, VREF. Accordingly, the frequency of VCO 290 is varied to control the frequency of the driver signal pulses used in switching switches 230 and 235 on and off. The frequency of the driver signal is varied until VO equals VREF.

In more detail, this particular embodiment of power supply 200 operates as follows. The AC mains voltage at inputs 207A, 207B is rectified into a pulsating DC current by rectifier 210. This pulsating DC current is filtered by capacitors 215 and 220 and results in a DC voltage across these capacitors. Half of this voltage appears at node 225 between capacitors 215, 220. Assuming that switch 230 is closed and switch 235 is open, a current I1 flows in the direction indicated in FIG. 2. The current I1 causes inductor 250 to build a magnetic field. The inductor current rises linearly as it follows V=L di/dt. The current I1 flows through the primary winding 245A of transformer 245 and returns via node 225 and capacitor 220 to ground as shown. The current I1 flowing in primary winding 245A causes a secondary current IS to be induced in the secondary winding 245B of transformer 245. This current will flow through either diode 255 or diode 260. For purposes of this example, it is assumed that secondary current IS flows through diode 255 in the direction indicated in FIG. 2. The secondary current IS then passes through node 265 to the parallel combination of output capacitor 20 and load RL 275.

Thus far, circuit operation has been described during the time that switch 230 is on. Switch 230 is now turned off by the switching signal from driver 280. However, switch 235B is not immediately turned on. At this point it is noted that switches 230 and 235 include parasitic body diodes 230A and 230B, respectively. These body diodes are parasitics which are inherent in the fabrication of MOS FET switches. If bipolar transistors are used as switches 230 and 235, then discrete diodes are added to these switches since bipolar transistors do not have intrinsic parasitic body diodes. When switch 230 is turned off while current was flowing in inductor 250 in the direction indicated for current I1, the field of the inductor is built up and, due to Lenz's law, inductor current will continue to flow in the same direction. Inductor 250 becomes a current source. The energy from inductor 250 assists transistor 230 in turning off and also assists transistor 235's intrinsic body diode 235B in turning on. After switch 230 has transitioned losslessly as described above and switch 235's body diode 235B is turned on, switch 235 is now turned on by the switching signal from driver 280. Turning switch 235 on causes inductor 250 to discharge with its current eventually changing direction and flowing toward node 240 as shown by current I1. Switch 235 then turns off under the instruction of the driver signal from drive 280. This transition again occurs losslessly due to body diode action. The driver signal from driver 280 then turns switch 230 back on and the process repeats. Zero voltage switching saves a substantial amount of energy by conserving energy that would otherwise be consumed during transistor switching.

While the zero voltage switching technology described above results in a more efficient power supply, unfortunately another problem is created, namely the problem of load dependency. For zero voltage switching to occur, there must be a substantial current flowing in inductor 250 to maintain the field therein. From the discussion above it will be recalled that the energy stored in the field of inductor 250 is what makes zero voltage switching possible. With very low loading, i.e. large impedance values for load 275, it is possible that the power drawn by the load may go lower than 1 watt. Under such very light loading conditions it is possible that the current drawn through inductor 250 will become so small that a critical point is passed where the field becomes so small that zero voltage switching is not sustained. It is possible to offset this effect to some degree by making inductor 250 very large to increase the field with lower currents. However this runs counter to the design goal of making the power supply smaller. To summarize, load dependency is the problem wherein the impedance value of the load must be sufficiently low to sustain a minimum current flow through the inductor to maintain the field of stored energy needed to provide zero voltage switching.

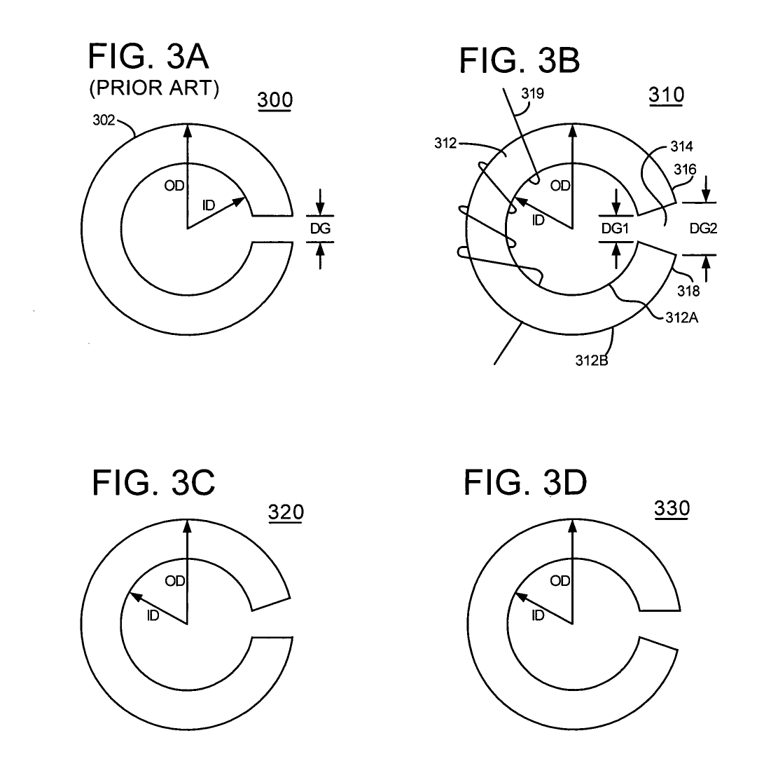

Past zero voltage switching power supplies have used a constant gap inductor, for example an inductor 300, the C-shaped core 302 of which is shown in FIG. 3A. In FIG. 3A the gap distance is shown as DG. The gap distance DG is constant as you move from the inner diameter (ID) to the outer diameter (OD) of inductor 300. In other words, the gap at the ID is the same as the gap at the OD. In contrast to the constant gap inductor of FIG. 3A, power supply 200 of FIG. 2 employs a non-constant gap inductor, for example inductor 310 of FIG. 3B, as inductor 250. Non-constant gap inductor 310 exhibits a C-shaped or toroid-shaped core 312 which is interrupted by a gap 314 that forms arms 316 and 318 on the opposed sides of the gap. A winding 319 is wound around inductor 310 as shown. In a non-constant gap inductor, the gap distance DG varies from a distance DG1 at the ID to a distance DG2 at the OD, or from the inner surface 312A to the outer surface 312B of the core. Such an inductor may also be referred to as a swinging choke herein and the gap may also be referred to as a load dependent gap. By varying the gap distance from ID to OD, inductor 310 is made to be load dependent because the inductance that it exhibits varies with the impedance of the load 275 which determines how much current is pulled through inductor 310.

In load dependent inductor 310, the inductance increases as the amount of current pulled through the inductor decreases. This compensates for the tendency of the zero voltage switching power supply 200 of FIG. 2 to lose regulation under light loads, i.e. high impedance loads. This compensation effect whereby the inductance increases as the current through the inductor decreases is due to the change in gap distance, DG, as you move from inner surface 312A to outer surface 312B of core 312 of inductor 310 of FIG. 3B. This phenomenon increases the operating range of a zero voltage switching power supply to operate with significantly lighter loads and still maintain regulation. For convenience in showing the geometries of the cores in FIG. 3A-3D, the inductors are shown without windings. Windings can be wrapped around the cores in the conventional fashion.

FIGS. 3C and 3D respectively show other non-constant gap inductors 320 and 330 which can be used in switching power supply 200 of FIG. 2. The gap geometries depicted in FIGS. 3C and 3D are variations of the gap geometry depicted in FIG. 3B.

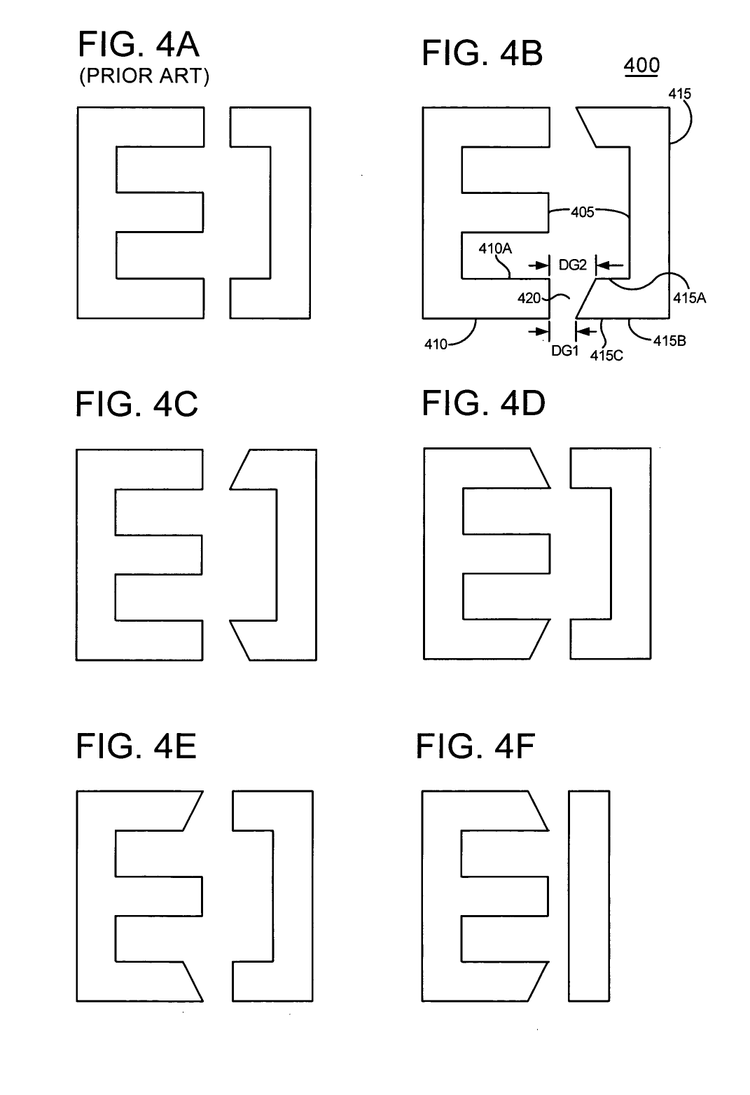

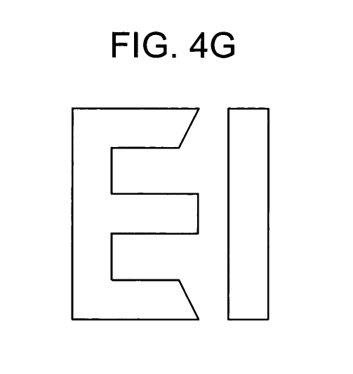

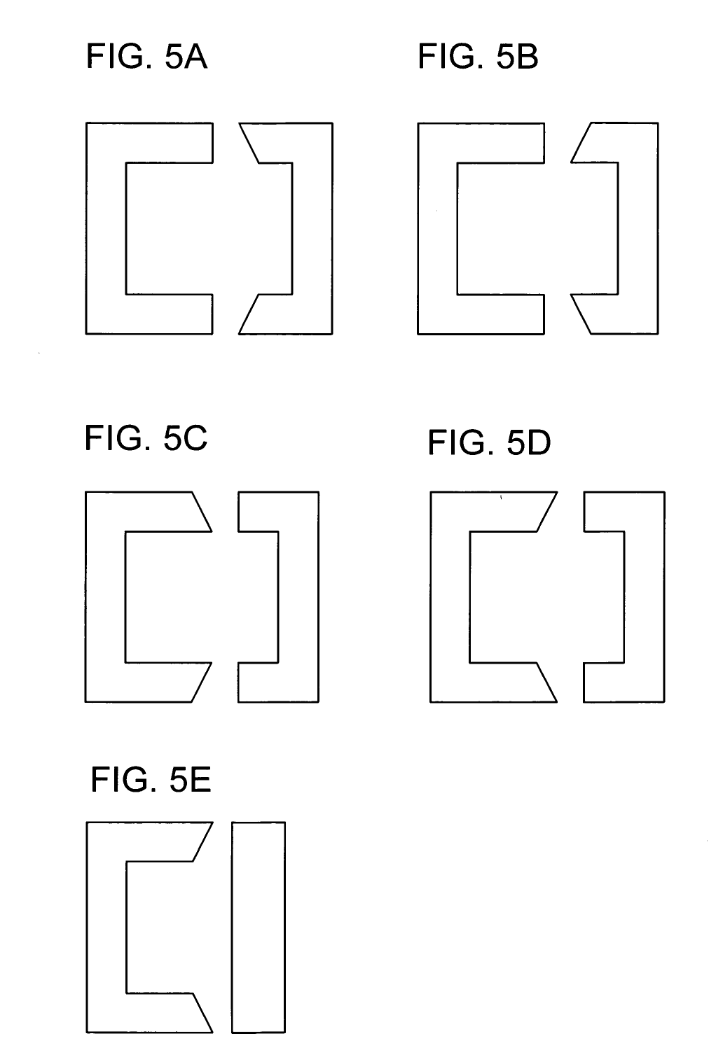

FIG. 4A depicts a conventional EI-shaped core for an inductor. FIG. 4B-4G depict EI-shaped core configurations that can be used to form load dependent inductor 250 in switching power supply 200. The depicted cores include E portions and I portions. The letters E and I refer to the geometries of the E and I portions. For example, as shown in FIG. 4B, core 405 of inductor 400 includes an E portion 410 and an I portion 415. I portion 415 includes an inner surface 415A and an outer surface 415B. A gap 420 is formed between an arm 410A of E portion 410 and an arm 415C of I portion 415. The gap distance DG of non-constant gap inductor 400 varies from a distance DG1 at outer surface 415B to a larger gap distance DG2 at inner surface 415A. The remaining inductors illustrated in FIG. 4C-4G also exhibit a varying gap distance or non-constant gap distance from the inner surface to the outer surface thereof. FIG. 5A-5E depict embodiments similar to those shown in FIG. 4B-4G except the center leg of the E portion is omitted.

A zero voltage switching power supply is thus disclosed which employs a load dependent non-constant gap inductor that allows the power supply to maintain zero voltage switching even when the power supply is operated with a very light load.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

1. A method of operating an information handling system (IHS) including a switching power supply, the method comprising:
storing energy in a load dependent inductor exhibiting an inductance which increases as current through the inductor decreases;
supplying energy from the load dependent inductor to switches in the switching power supply to achieve zero voltage switching of the switches; and
providing energy from the switching power supply to power the IHS.

2. The method of claim 1 wherein the load dependent inductor is driven by first and second switches arranged in a complementary switching configuration.

3. The method of claim 2 wherein the first and second switches are switching transistors.

4. The method of claim 1 wherein the load dependent inductor includes a non-constant gap.

5. The method of claim 1 wherein the load dependent inductor includes a substantially C-shaped core with a non-constant gap.

6. The method of claim 1 wherein the load dependent inductor includes a substantially E-I shaped core with a non constant gap.

7. A method of operating a switching power supply comprising:
storing energy in a load dependent inductor which exhibits an inductance that increases as current through the inductor decreases;
supplying energy from the load dependent inductor to switches in the switching power supply to achieve zero voltage switching of the switches; and
providing energy from the switching power supply to an output.

8. The method of claim 7 wherein the load dependent inductor is driven by first and second switches arranged in a complementary switching configuration.

9. The method of claim 8 wherein the first and second switches are switching transistors.

10. The method of claim 7 wherein the load dependent inductor includes a non-constant gap.

11. The method of claim 7 wherein the load dependent inductor includes a substantially C-shaped core with a non-constant gap.

12. The method of claim 7 wherein the load dependent inductor includes a substantially E-I shaped core with a non constant gap.

13. An information handling system (IHS) comprising:
a processor;
a memory coupled to the processor;
a power input coupled to the processor and the memory;
a switching power supply coupled to the power input, the switching power supply including:
a load dependent inductor for storing energy, the load dependent inductor exhibiting an inductance which increases as current through the inductor decreases; and
first and second switches arranged in complementary configuration, the load dependent inductor supplying energy to the first and second switches to achieve zero voltage switching of the first and second switches.

14. The IHS of claim 13 wherein the load dependent inductor is driven by first and second switches arranged in a complementary switching configuration.

15. The IHS of claim 14 wherein the first and second switches are switching transistors.

16. The IHS of claim 13 wherein the load dependent inductor includes a non-constant gap.

17. The IHS of claim 13 wherein the load dependent inductor includes a substantially C-shaped core with a non-constant gap.

18. The IHS of claim 13 wherein the load dependent inductor includes a substantially E-I shaped core with a non constant gap.

19. A zero voltage switching power supply including:
a load dependent inductor for storing energy, the load dependent inductor exhibiting an inductance which increases as current through the inductor decreases; and
first and second switches arranged in complementary configuration, the load dependent inductor being coupled to the first and second switches, the load independent inductor supplying energy to the first and second switches to achieve zero voltage switching of the first and second switches.

20. The zero voltage switching power supply of claim 19 wherein the first and second switches are switching transistors.

21. The zero voltage switching power supply of claim 19 wherein the load dependent inductor includes a non-constant gap.

22. The zero voltage switching power supply of claim 19 wherein the load dependent inductor includes a substantially C-shaped core with a non-constant gap.

23. The zero voltage switching power supply of claim 19 wherein the load dependent inductor includes a substantially E-I shaped core with a non constant gap.

24. An information handling system (IHS) comprising:
a power input coupled to a processor and a memory;
a switching power supply coupled to the power input, the switching power supply including means for:
storing energy in a load dependent inductor exhibiting an inductance which increases as current through the inductor decreases;
supplying energy from the load dependent inductor to switches in the switching power supply to achieve zero voltage switching of the switches; and
providing energy from the switching power supply to power the IHS.
